(19) United States
(12) Patent Application Publication
(10) Pub. No.: US 2024/0352255 A1
(43) Pub. Date: Oct. 24, 2024

(54) A BURNING-RESISTANT THERMOPLASTIC COMPOSITION

(71) Applicant: UPM-Kymmene Corporation, Helsinki (FI)

(72) Inventors: Barbara GALL, Helsinki (FI); Florian DIEHL, Helsinki (FI); Mauno MIETTINEN, Helsinki (FI)

(21) Appl. No.: 18/701,731

(22) PCT Filed: Oct. 21, 2021
(86) PCT No.: PCT/FI2021/050706

§ 371 Date: Apr. 16, 2024

(51) Int. Cl. C08L 97/00; C08L 23/12; C08L 25/06

(52) U.S. Cl. CPC C08L 97/005; C08L 23/12; C08L 25/06

(57) ABSTRACT

A burning-resistant thermoplastic composition comprising at least one polymer and a lignin-based filler is disclosed. Further, is disclosed the use of a lignin-based filler for producing a burning-resistant thermoplastic composition and a method for producing a burning-resistant thermoplastic composition. Further is disclosed an article and the use of the burning-resistant thermoplastic composition.

### TECHNICAL FIELD

The present disclosure relates to a burning-resistant thermoplastic composition. The present disclosure further relates to the use of a lignin-based filler for improving the burning resistance of a thermoplastic composition. The present disclosure further relates to a method for producing a burning-resistant thermoplastic composition. The present disclosure further relates to an article and to the use of the burning-resistant thermoplastic composition.

### BACKGROUND

In the light of sustainability and circular economy it is desired to use biobased materials in thermoplastic compositions or materials, such as packaging materials. The thermal stability of thermoplastic compositions is an important property for the processing these materials, too. To provide environmentally friendly solutions in relation to thermoplastic composition is to be achieved.

### SUMMARY

A burning-resistant thermoplastic composition is disclosed. The burning-resistant thermoplastic composition comprises at least one polymer and a lignin-based filler, wherein the lignin-based filler is prepared from lignin material subjected to hydrothermal carbonization treatment, and wherein the lignin-based filler comprises carbon in a total amount of 62-70 weight-% and ash in a total amount of at most 3 weight-%, and wherein the burning rate of the burning-resistant thermoplastic composition is at least 20 percent lower than the burning rate of a corresponding thermoplastic composition, wherein the corresponding thermoplastic composition is prepared in an otherwise similar manner as the burning-resistant thermoplastic composition but where the lignin material used for preparing the lignin-based filler has not been subjected to hydrothermal carbonization treatment.

Further is disclosed the use of a lignin-based filler for improving the burning resistance of a thermoplastic composition. The burning-resistant thermoplastic composition comprises at least one polymer and the lignin-based filler, wherein the lignin-based filler is prepared from lignin material subjected to hydrothermal carbonization treatment, and wherein the lignin-based filler comprises carbon in a total amount of 62-70 weight-% and ash in a total amount of at most 3 weight-%, and wherein the burning rate of the burning-resistant thermoplastic composition is at least 20 percent lower than the burning rate of a corresponding thermoplastic composition, wherein the corresponding thermoplastic composition is prepared in an otherwise similar manner as the burning-resistant thermoplastic composition but where the lignin material used for preparing the lignin-based filler has not been subjected to hydrothermal carbonization treatment.

Further is disclosed a method for producing a burning-resistant thermoplastic composition comprising at least one polymer and a lignin-based filler, wherein the method comprises:
providing at least one polymer and a lignin-based filler, wherein the lignin-based filler is prepared from lignin material subjected to hydrothermal carbonization treatment, wherein the lignin-based filler comprises carbon in a total amount of 62-70 weight-% and ash in a total amount of at most 3 weight-%; and
combining the at least one polymer and the lignin-based filler to form the burning-resistant thermoplastic composition, wherein
the burning rate of the burning-resistant thermoplastic composition is at least 20 percent lower compared to the burning rate of a corresponding thermoplastic composition, wherein the corresponding thermoplastic composition is prepared in an otherwise similar manner as the burning-resistant thermoplastic composition but where the lignin material used for preparing the lignin-based filler has not been subjected to hydrothermal carbonization treatment.

Further is disclosed an article comprising the burning-resistant thermoplastic composition as defined in the current specification.

Further is disclosed the use of the thermoplastic composition as defined in the current specification in a packaging, a housing, an automotive part, an aviation part, a marine part, a machine part, a sports equipment, a sports equipment part, a leisure equipment, a leisure equipment part, a tool, a part of a tool, a pipe, a membrane, a tube, a fitting, a bottle, a film, a bag, a sack, a textile, a rope, a container, a tank, an electrical component, an electronic component, a part for energy generation, a toy, an appliance, a kitchenware, a tableware, a flooring, a fabric, a medical application, a food contact material, a construction material, a drinking water application, and/or a furniture.

### DETAILED DESCRIPTION

A burning-resistant thermoplastic composition is disclosed. The burning-resistant thermoplastic composition comprises at least one polymer and a lignin-based filler, wherein the lignin-based filler is prepared from lignin material subjected to hydrothermal carbonization treatment, and wherein the lignin-based filler comprises carbon in a total amount of 62-70 weight-% and ash in a total amount of at most 3 weight-%, and wherein the burning rate of the burning-resistant thermoplastic composition is at least 20 percent lower than the burning rate of a corresponding thermoplastic composition, wherein the corresponding thermoplastic composition is prepared in an otherwise similar manner as the burning-resistant thermoplastic composition but where the lignin material used for preparing the lignin-based filler has not been subjected to hydrothermal carbonization treatment.

Further is disclosed the use of a lignin-based filler for improving the burning resistance of a thermoplastic composition. The burning-resistant thermoplastic composition comprises at least one polymer and the lignin-based filler, wherein the lignin-based filler is prepared from lignin material subjected to hydrothermal carbonization treatment, and wherein the lignin-based filler comprises carbon in a total amount of 62-70 weight-% and ash in a total amount of at most 3 weight-%, and wherein the burning rate of the burning-resistant thermoplastic composition is at least 20 percent lower than the burning rate of a corresponding thermoplastic composition, wherein the corresponding thermoplastic composition is prepared in an otherwise similar manner as the burning-resistant thermoplastic composition but where the lignin material used for preparing the lignin-based filler has not been subjected to hydrothermal carbonization treatment.

Further is disclosed a method for producing a burning-resistant thermoplastic composition comprising at least one polymer and a lignin-based filler, wherein the method comprises:
providing at least one polymer and a lignin-based filler, wherein the lignin-based filler is prepared from lignin material subjected to hydrothermal carbonization treatment, wherein the lignin-based filler comprises carbon in a total amount of 62-70 weight-% and ash in a total amount of at most 3 weight-%; and
combining the at least one polymer and the lignin-based filler to form the burning-resistant thermoplastic composition, wherein
the burning rate of the burning-resistant thermoplastic composition is at least 20 percent lower compared to the burning rate of a corresponding thermoplastic composition, wherein the corresponding thermoplastic composition is prepared in an otherwise similar manner as the burning-resistant thermoplastic composition but where the lignin material used for preparing the lignin-based filler has not been subjected to hydrothermal carbonization treatment.

Further is disclosed an article comprising the burning-resistant thermoplastic composition as defined in the current specification. In one embodiment, thermoplastic composition has been shaped into the article by extrusion, injection molding, compression molding, blow molding, injection blow molding, injection stretch blow molding, thermoforming, vacuum forming, melt spinning, electrospinning, melt blowing, film blowing, film casting, extrusion coating, rotational molding, coextrusion, laminating, calendering, fused deposition modeling, or by any combination of these.

Further is disclosed the use of the thermoplastic composition as defined in the current specification in a packaging, a housing, an automotive part, an aviation part, a marine part, a machine part, a sports equipment, a sports equipment part, a leisure equipment, a leisure equipment part, a tool, a part of a tool, a pipe, a membrane, a tube, a fitting, a bottle, a film, a bag, a sack, a textile, a rope, a container, a tank, an electrical component, an electronic component, a part for energy generation, a toy, an appliance, a kitchenware, a tableware, a flooring, a fabric, a medical application, a food contact material, a construction material, a drinking water application, and/or a furniture.

Thus, the term “corresponding thermoplastic composition” is to be understood as referring to a thermoplastic composition that has been prepared in an otherwise similar manner as the burning-resistant thermoplastic composition but where hydrothermal carbonization treatment has not been used for preparing the lignin-based filler. I.e. all the other components and their amounts as well as process steps used to prepare the corresponding thermoplastic composition are remained the same as when preparing the burning-resistant thermoplastic composition but the step of using hydrothermal carbonization treatment of the lignin material is omitted when preparing the lignin-based filler for the corresponding thermoplastic composition.

The burning rate may be determined according to standard ISO 3795:1989 (Road vehicles, and tractors and machinery for agriculture and forestry—Determination of burning behavior of interior materials (Horizontal burning test); conditioning: 23° C. and 50% relative humidity (R.H)., sample size: 147 mm×100 mm×2 mm).

In one embodiment, the burning rate of the burning-resistant thermoplastic composition is at least 30 percent, or at least 40 percent, or at least 50 percent, or at least 60 percent, or at least 70 percent, lower than the burning rate of the corresponding thermoplastic composition.

The thermoplastic composition may contain 0.1-65 weight-%, or 0.3-60 weight-%, or 0.5-50 weight-%, or 1-40 weight-%, or 1.2-30 weight-%, or 1.5-20 weight-%, or 2-10 weight-%, or 2.5-5 weight-%, of the lignin-based filler based on the total weight of the burning-resistant thermoplastic composition. In one embodiment, the burning-resistant thermoplastic composition comprises the lignin-based filler in a total amount of 0.1-60 weight-%, or 0.5-50 weight-%, or 1-45 weight-%, based on the total weight of the burning-resistant thermoplastic composition.

The “total weight” should in this specification be understood, unless otherwise stated, as the weight of all the components of the burning-resistant thermoplastic composition including possible moisture.

A thermoplastic composition, or thermosoftening plastic composition as it may also be called, is a plastic polymer material that becomes pliable or moldable at a certain elevated temperature and solidifies upon cooling.

The thermoplastic composition may be prepared by using at least one polymer and a lignin-based filler. In the thermoplastic composition the at least one polymer and the lignin-based filler may be mixed together but they may not have reacted with each other. Further components or materials, such as additives, lubricants, stabilizers, antioxidants, other fillers, etc., may also be used for preparing the thermoplastic composition.

In one embodiment, combining the at least one polymer and the lignin-based filler comprises preparing a masterbatch and then compounding the polymer and the lignin-based filler. In one embodiment, combining the at least one polymer and the lignin-based filler comprises combining the at least one polymer, the lignin based filler and additives and molding the formed burning-resistant thermoplastic composition. In one embodiment, combining the at least one polymer and the lignin-based filler comprises directly compounding the at least one polymer and the lignin-based filler under the processing temperatures suitable for each polymer type. The processing temperatures are elevated temperatures and are defined by the polymer provider for each polymer.

When preparing the burning-resistant thermoplastic composition a so-called masterbatch may first be prepared by using polymer and the lignin-based filler. The masterbatch may be prepared by mixing the polymer and the lignin-based filler at an elevated temperature. Also other additives, lubricants, stabilizer, antioxidants, other fillers, etc. as needed may be included in the masterbatch. A masterbatch is generally considered a solid product (normally of plastic, rubber, or elastomer) in which pigments or fillers are optimally dispersed at high concentration in a carrier material. The carrier material is compatible with the main plastic in which it will be blended during molding, whereby the final plastic product, i.e. the thermoplastic composition, obtains the color or properties from the masterbatch.

Alternatively, the thermoplastic composition is directly compounded at an elevated temperature from the polymer(s) and the lignin-based filler. Also other additives, lubricants, stabilizers, antioxidants, other fillers, etc. as needed may be directly compounded with the polymer and the lignin-based filler.

The temperature used when combining the at least one polymer and the lignin based filler may vary depending on the type of polymer used. The suitable temperature to be used for each polymer is readily available to the person skilled in the art. Also the polymer providers define suitable processing temperatures for different polymers. Generally, temperatures of e.g. 150-440° C., or 180-350° C., or 200-300° C., may be used.

The thermoplastic composition may comprise at least one polymer, e.g. at least two different polymers, at least three different polymers, at least four different polymers etc. The polymer may be any polymer selected from the group of thermoplastic polymers or a combination of different thermoplastic polymers. The polymer may be selected from one or more of the following: polyethylene, polypropylene, polystyrene, ethylene-vinyl acetate (EVA), polybutylene adipate terephthalate (PBAT), polyamide, polyacrylate, polyester, acrylonitrile butadiene styrene (ABS), polycarbonate, polylactic acid (PLA), polyvinyl chloride (PVC) etc. In one embodiment, the polymer is selected from polypropylene and/or polystyrene. I.e. one type of polymer may be used for producing the burning-resistant thermoplastic composition or a combination of two or more different polymers may be used.

By the expression “lignin-based filler” should be understood in this specification, unless otherwise stated, as referring to a filler that has been prepared from lignin material subjected to hydrothermal carbonization treatment (HTC).

Hydrothermal carbonization (HTC) treatment may also be referred to as “aqueous carbonization at elevated temperature and pressure”. The hydrothermal carbonization treatment of lignin material refers to a thermochemical conversion process of lignin-containing material in aqueous an suspension. Hydrothermal carbonization treatment of lignin produces lignin derivatives having high carbon content and functional groups. It is thus a chemical process for the conversion of organic compounds to structured carbons.

The lignin material used for preparing the lignin-based filler may be selected from a group consisting of kraft lignin, steam explosion lignin, biorefinery lignin, supercritical separation lignin, hydrolysis lignin, flash precipitated lignin, biomass originating lignin, lignin from alkaline pulping process, lignin soda process, lignin from from organosolv pulping, lignin from alkali process, lignin from enzymatic hydrolysis process, and any combination thereof. In one embodiment, the lignin is wood based lignin. The lignin can originate from softwood, hardwood, annual plants or from any combination thereof.

By “kraft lignin” is to be understood in this specification, unless otherwise stated, lignin that originates from kraft black liquor. Black liquor is an alkaline aqueous solution of lignin residues, hemicellulose, and inorganic chemicals used in a kraft pulping process. The black liquor from the pulping process comprises components originating from different softwood and hardwood species in various proportions. Lignin can be separated from the black liquor by different, techniques including e.g. precipitation and filtration. Lignin usually begins precipitating at pH values below 11-12. Different pH values can be used in order to precipitate lignin fractions with different properties. These lignin fractions differ from each other by molecular weight distribution, e.g. Mw and Mn, polydispersity, hemicellulose and extractive contents. The molar mass of lignin precipitated at a higher pH value is higher than the molar mass of lignin precipitated at a lower pH value. Further, the molecular weight distribution of lignin fraction precipitated at a lower pH value is wider than of lignin fraction precipitated at a higher pH value. The precipitated lignin can be purified inorganic impurities, hemicellulose and wood extractives using acidic washing steps. Further purification can be achieved by filtration.

The term “flash precipitated lignin” should be understood in this specification as lignin that has been precipitated from black liquor in a continuous process by decreasing the pH of a black liquor flow, under the influence of an over pressure of 200-1000 kPa, down to the precipitation level of lignin using a carbon dioxide based acidifying agent, preferably carbon dioxide, and by suddenly releasing the pressure for precipitating lignin. The method for producing flash precipitated lignin is disclosed in patent application FI 20106073. The residence time in the above method is under 300 s. The flash precipitated lignin particles, having a particle diameter of less than 2 μm, form agglomerates, which can be separated from black liquor using e.g. filtration. The advantage of the flash precipitated lignin is its higher reactivity compared to normal kraft lignin. The flash precipitated lignin can be purified and/or activated if needed for the further processing.

The lignin may be derived from an alkali process. The alkali process can begin with liquidizing biomass with strong alkali followed by a neutralization process. After the alkali treatment, the lignin can be precipitated in a similar manner as presented above.

The lignin may be derived from steam explosion. Steam explosion is a pulping and extraction technique that can be applied to wood and other fibrous organic material.

By “biorefinery lignin” is to be understood in this specification, unless otherwise stated, lignin that can be recovered from a refining facility or process where biomass is converted into fuel, chemicals and other materials.

By “supercritical separation lignin” is to be understood in this specification, unless otherwise stated, lignin that can be recovered from biomass using supercritical fluid separation or extraction technique. Supercritical conditions correspond to the temperature and pressure above the critical point for a given substance. In supercritical conditions, distinct liquid and gas phases do not exist. Supercritical water or liquid extraction is a method of decomposing and converting biomass into cellulosic sugar by employing water or liquid under supercritical conditions. The water or liquid, acting as a solvent, extracts sugars from cellulose plant matter and lignin remains as a solid particle.

The lignin may be derived from a hydrolysis process. The lignin derived from the hydrolysis process can be recovered from paper-pulp or wood-chemical processes.

The lignin may originate from an organosolv process. Organosolv is a pulping technique that uses an organic solvent to solubilize lignin and hemicellulose.

In one embodiment, the lignin-based filler is prepared from lignin material derived from enzymatic hydrolysis process and/or from a Kraft process and subjected to the hydrothermal carbonization treatment. In one embodiment, the lignin-based filler is prepared from lignin material derived from enzymatic hydrolysis process and subjected to the hydrothermal carbonization treatment. In one embodiment, the lignin-based filler is prepared from lignin material derived from a Kraft process and subjected to the hydrothermal carbonization treatment.

In one embodiment, the starting material for preparing the lignin-based filler is lignin material taken from enzymatic hydrolysis process. In one embodiment, the enzymatic hydrolysis comprises enzymatic hydrolysis of a plant-based feedstock, such as a wood-based feedstock. In one embodiment, the enzymatic hydrolysis comprises enzymatic hydrolysis of cellulose. Enzymatic hydrolysis is a process, wherein enzyme(s) assist(s) in cleaving bonds in molecules with the addition of elements of water. In one embodiment, the enzymatic hydrolysis comprises enzymatic hydrolysis of cellulose. In one embodiment, the lignin-based filler is prepared from lignin material derived from enzymatic hydrolysis process that is subjected to hydrothermal carbonization treatment.

In one embodiment, the lignin-based filler is prepared from lignin derived from pulping of wood, e.g. Kraft lignin.

The lignin-based filler as disclosed in the current specification may be prepared as disclosed below. The lignin material to be used may be derived from e.g. a process wherein the lignin is formed in enzymatic hydrolysis of lignocellulosic feedstock or the lignin may be derived from a Kraft process. Also other lignin sources may be used as disclosed in the current specification.

The derived lignin material may be dissolved in alkaline solution, such as NaOH. The dissolution may be accomplished by heating the mixture of lignin and alkaline solution to about 80° C., adjusting the pH to a value above 7, such as 9-11, and mixing the mixture of lignin and alkaline solution for a predetermined time. The mixing time may be continued for about 2-3 hours. The exact pH value is determined based on the grade target of the product.

The dissolved lignin material may then be subjected to hydrothermal carbonization treatment (HTC).

The hydrothermal carbonization treatment may take place in a reactor (HTC reactor), or if needed, in several parallel reactors, working in a batchwise manner. The dissolved lignin material may be pre-heated before being entered in the HTC reactor(s). The temperature in the HTC reactor(s) may be 150-250° C. and the pressure may be 20-30 bar. The residence time in the HTC reactor(s) may be about three to six hours. In the HTC reactor, the lignin is carbonized, whereby a stabilized lignin derivative with a high specific surface area may be precipitated. The formed slurry comprising the carbonized lignin may then be removed and cooled. Consequently, a slurry comprising lignin-based filler is formed.

The slurry comprising lignin-based filler may be fed to a separation unit, wherein the precipitated lignin-based filler may be separated from the slurry. The separated lignin-based filler may be dried and recovered. Before drying, the lignin-based filler may be, if needed, washed. The crushed lignin particles may be dried and used as the lignin-based filler.

During the above described process lignin polymers are connected to each other. Thus, the lignin-based filler may be considered to comprise or consist of lignin polymers that are linked together. Lignin polymers that are connected or linked together may not be soluble anymore. However, lower lignin polymer chains still remain soluble and thus can be subjected to standard analytical techniques like size exclusion chromatography or nuclear magnetic resonance spectroscopy (NMR spectroscopy), which require the analyte to be dissolved in a solvent. Thus, different properties of the soluble fraction of the lignin-based filler may be determined.

In one embodiment, the lignin-based filler comprises ash in a total amount of 0.1-3 weight-%, or 0.1-2.5 weight-%, or 0.2-2.0 weight-%, or 0.3-1.5 weight-%, or 0.4-1.0 weight-%. The ash content can be determined according to the standard DIN 51719.

The inventors surprisingly found out that when lignin material from e.g. enzymatic hydrolysis process is used for producing the lignin-based filler, one is able to lower the ash content of the lignin-based filler. The lower ash content has the added utility of e.g. higher purity of the lignin-based filler.

The lignin-based filler may comprise carbon in a total amount of 62-70 weight-%. In one embodiment, the lignin-based filler comprises carbon in a total amount of 63-69 weight-%, or 64-68 weight-%. The amount of carbon in the lignin-based filler may be determined according to standard DIN 51732 (1997). The inventors surprisingly found out that the amount of carbon in the lignin-based filler has the added utility of beneficially affecting the burning resistance of the thermoplastic composition compared to other lignin-containing fillers with a less amount of carbon. The amount of carbon in the lignin-based filler may thus assist in preventing burning to take place.

In one embodiment, the solubility of the lignin-based filler in 0.1 M NaOH is 1-40 weight-%, or 3-35 weight-%, or 5-30 weight-%. The solubility may be measured in the following manner: First a sample is dried at a temperature of 60° C. for four hours. A sample mass of 0.5 gram is weighed and suspended in 50 ml of 0.1 M NaOH at a concentration of 1% having a temperature of 22° C. Mixing is continued for 1 hour, where after the sample is placed on a glass microfiber paper (1.6 μm) and the filter paper with the sample is dried at a temperature of 60° C. for 2 hours. The portion of the sample has which has dissolved can be determined gravimetrically.

In one embodiment, the lignin-based filler has a weight average molecular weight (Mw) of 1000-4000 Da, or 1300-3700 Da, or 1700-3200 Da, or 2500-3000 Da, or 2600-2900 Da, or 2650-2850 Da, when determined based on the soluble fraction of the lignin-based filler. The weight average molecular weight may be determined with size exclusion chromatography (SEC) by using 0.1 M NaOH as eluent and a sample amount of about 1 mg/ml, which is dissolved in 0.1 M NaOH. The molecular weights measured against polystyrenesulfonate standards. UV detector at wavelength of 280 nm is used.

The polydispersity index (PDI) of the lignin-based filler may be 1.5-5.0, or 1.8-4.5, or 1.9-4.3, or 2.1-4.0, or 2.4-3.5, or 2.6-3.2, when determined based on the soluble fraction of the lignin-based filler. The polydispersity index may be determined by size-exclusion chromatography (SEC). The PDI is a measure of the distribution of molecular mass in a given polymer sample. The PDI is calculated as the weight average molecular weight (Mw) divided by the number average molecular weight (Mn). PDI indicates the distribution of individual molecular masses in a batch of polymers.

The lignin-based filler may have a STSA number of 3-150 m²/g, or 5-100 m²/g, or 7-60 m²/g. The STSA number may be determined according to standard ASTM D6556.

In one embodiment, the lignin-based filler has a density of at most 1.5 g/cm³. In one embodiment, the lignin-based filler has a density of 1.0-1.5 g/cm³, or 1.15-1.35 g/cm³, or 1.1-1.4 g/cm³. The density may be determined according to standard ISO 21687.

The burning-resistant thermoplastic composition as disclosed in the current specification has the added utility of showing an improved burning resistance. The thermoplastic composition thus has the added utility of being thermally stable. The inventors surprisingly found out that lignin-based filler has a carbon content that beneficially affects the ability of the thermoplastic composition to resist burning.

The burning-resistant thermoplastic composition as disclosed in the current specification has the added utility of showing good stability when compared to e.g. compositions prepared by using carbon black as the filler.

### EXAMPLES

Reference will now be made in detail to various embodiments.

The description below discloses some embodiments in such a detail that a person skilled in the art is able to utilize the embodiments based on the disclosure. Not all steps or features of the embodiments are discussed in detail, as many of the steps or features will be obvious for the person skilled in the art based on this specification.

### Example 1—Testing the Burning Resistance of Thermoplastic Compositions

In this example the purpose was to evaluate the burning resistance of the burning resistant thermoplastic composition by comparing to the burning-resistance of corresponding thermoplastic compositions. As above indicated the corresponding thermoplastic composition was prepared in an otherwise similar manner as the burning-resistant thermoplastic composition but the lignin material was not subjected to hydrothermal carbonization treatment during the preparation of the lignin-based filler. The filler used in the corresponding thermoplastic composition is called pristine lignin in this example.

As a comparative examples were also prepared a native thermoplastic composition, which did not contain any filler, and a thermoplastic composition with using carbon black as the filler.

The lignin-based filler was prepared by following the description provided above in the current specification by using lignin material from enzymatic hydrolysis subjected to hydrothermal carbonization treatment. The pristine lignin was lignin taken from the enzymatic hydrolysis but that had not been subjected to the hydrothermal carbonization treatment. The carbon black used was MONARCH®800 provided by Cabot. Properties of the lignin-based filler, and the pristine lignin were measured and are presented in the below table 1:

TABLE 1

| | | | Lignin- | |
|---|---|---|---|---|
| Value | Measurement | | based | Pristine |
| measured | method | Unit | filler | lignin |
| STSA | ASTM D6556 | m²/g | 45.5 | 9.3 |
| Density | ISO 21687 | g/cm³ | 1.3-1.4 | 1.3-1.4 |
| C content | DIN 51732 | % | 65.93 | 60.3 |
| H content | DIN 51732 | % | 5.57 | 5.90 |
| N content | DIN 51732 | % | 0.11 | 0.76 |
| S content | DIN 51732 | % | 0.03 | <0.05 |
| Ash Content | DIN 51719 | % | 2.3 | 0.4 |
| Solubility | As described | % | 26.2 | 40.8 |
| 0.1M NaOH | in this | | | |
| | specification | | | |
| pH | ASTM D1512 | — | 8.4 | 6-7 |
| Moisture | ASTM D1509 | % | 0.7 | 2.4 |
| content | | | | |

The carbon content of the carbon black was >95% and the density was 1.8 g/cm3.

Firstly the following thermoplastic compositions were prepared:

TABLE 2

| | Polypropylene | Polystyrene |
|---|---|---|
| Filler type | (PP) | (PS) |
| 40 weight-% carbon black | x | x |
| 40 weight-% pristine lignin | x | x |
| 40 weight-% lignin-based filler | x | x |

The thermoplastic compositions were prepared by combining the following components under the processing temperatures suitable for each polymer type: 40 weight-% of filler, 52 weight-% of the polymer, and in total 8 weight-% of an additive package (consisting of 2% of Ca-stearate (lubricant), 2% of Irganox 1010 antioxidant, 4% of polyethylene wax (lubricant)).

3 kg of each type of thermoplastic composition was made, and this was done at a 40 weight-% filler-loading. The burning behavior was tested based on the horizontal burning test ISO 3795:1989. The testing was done on molded masterbatches of PP and PS and their unfilled counterpart (comparative example). The results of the burning test are presented in the below table:

TABLE 3
Results of the burning tests

| | Burning rate |
|---|---|
| Sample | mm/min |
| Pure PP, no filler | 52 |
| PP 40% carbon black | 14 |
| PP 40% lignin-based filler | 19 |
| PP 40% pristine lignin | 79 |
| Pure PS, no filler | 47 |
| PS 40% carbon black | 23 |
| PS 40% lignin-based filler | 47 |
| PS 40% pristine lignin | 129 |

From the test results one can see that the burning behavior of the burning-resistant thermoplastic composition is considerably better than for the corresponding thermoplastic composition. The result is rather close to the thermoplastic composition were carbon black was used as the filler.

It is obvious to a person skilled in the art that with the advancement of technology, the basic idea may be implemented in various ways. The embodiments are thus not limited to the examples described above; instead they may vary within the scope of the claims.

The embodiments described hereinbefore may be used in any combination with each other. Several of the embodiments may be combined together to form a further embodiment. A thermoplastic composition, the use, or a method, disclosed herein, may comprise at least one of the embodiments described hereinbefore. It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items. The term “comprising” is used in this specification to mean including the feature(s) or act(s) followed thereafter, without excluding the presence of one or more additional features or acts.

1. A burning-resistant thermoplastic composition comprising:
at least one polymer and a lignin-based filler, wherein the lignin-based filler is prepared from lignin material subjected to hydrothermal carbonization treatment, and wherein the lignin-based filler comprises carbon in a total amount of 62-70 weight-% and ash in a total amount of at most 3 weight-%,
wherein the burning rate of the burning-resistant thermoplastic composition is at least 20 percent lower than the burning rate of a corresponding thermoplastic composition, and
wherein the corresponding thermoplastic composition is prepared in an otherwise similar manner as the burning-resistant thermoplastic composition but where the lignin material used for preparing the lignin-based filler has not been subjected to hydrothermal carbonization treatment.

2. The burning-resistant thermoplastic composition of claim 1, wherein the burning rate of the burning-resistant thermoplastic composition is at least 30 percent lower than the burning rate of the corresponding thermoplastic composition.

3. The burning-resistant thermoplastic composition of claim 1, wherein the burning-resistant thermoplastic composition comprises the lignin-based filler in a total amount of 0.1-60 weight-%, based on the total weight of the burning-resistant thermoplastic composition.

4. The burning-resistant thermoplastic composition of claim 1, wherein the lignin material used for preparing the lignin-based filler is derived from an enzymatic hydrolysis process and/or from a Kraft process.

5. The burning-resistant thermoplastic composition of claim 1, wherein the lignin-based filler comprises ash in a total amount of 0.1-2.5 weight-%.

6. The burning-resistant thermoplastic composition of claim 1, wherein the solubility of the lignin-based filler in 0.1 M NaOH is 1-40 weight-%.

7. The burning-resistant thermoplastic composition of claim 1, wherein the lignin-based filler has a weight average molecular weight (Mw) of 1000-4000 Da when determined based on the soluble fraction of the lignin-based filler.

8. The burning-resistant thermoplastic composition of claim 1, wherein the polydispersity index of the lignin-based filler is 1.5-5.0, when determined based on the soluble fraction of the lignin-based filler.

9. The use of a lignin-based filler for improving the burning resistance of a thermoplastic composition comprising at least one polymer and the lignin-based filler, wherein the lignin-based filler is prepared from lignin material subjected to hydrothermal carbonization treatment, and wherein the lignin-based filler comprises carbon in a total amount of 62-70 weight-% and ash in a total amount of at most 3 weight-%, and wherein
the burning rate of the burning-resistant thermoplastic composition is at least 20 percent lower compared to the burning rate of a corresponding thermoplastic composition, wherein the corresponding thermoplastic composition is prepared in an otherwise similar manner as the burning-resistant thermoplastic composition but where the lignin material used for preparing the lignin-based filler has not been subjected to hydrothermal carbonization treatment.

10. The use of claim 9, wherein the burning rate of the burning-resistant thermoplastic composition is at least 30 percent lower than the burning rate of the corresponding thermoplastic composition.

11. The use of claim 9, wherein the burning-resistant thermoplastic composition comprises the lignin-based filler in a total amount of 0.1-60 weight-%, based on the total weight of the burning-resistant thermoplastic composition.

12. The use of claim 9, wherein the lignin material used for preparing the lignin-based filler is derived from an enzymatic hydrolysis process and/or from a Kraft process.

13. The use of claim 9, wherein the lignin-based filler comprises ash in a total amount of 0.1-2.5 weight-%.

14. The use of claim 9, wherein the solubility of the lignin-based filler in 0.1 M NaOH is 1-40 weight-%.

15. The use of claim 9, wherein the lignin-based filler has a weight average molecular weight (Mw) of 1000-4000 Da, when determined based on the soluble fraction of the lignin-based filler.

16. The use of claim 9, wherein the polydispersity index of the lignin-based filler is 1.5-5.0, when determined based on the soluble fraction of the lignin-based filler.

17. A method for producing a burning-resistant thermoplastic composition comprising at least one polymer and a lignin-based filler, wherein the method comprises:
providing at least one polymer and a lignin-based filler, wherein the lignin-based filler is prepared from lignin material subjected to hydrothermal carbonization treatment, wherein the lignin-based filler comprises carbon in a total amount of 62-70 weight-% and ash in a total amount of at most 3 weight-%; and
combining the at least one polymer and the lignin-based filler to form the burning-resistant thermoplastic composition, wherein
the burning rate of the burning-resistant thermoplastic composition is at least 20 percent lower compared to the burning rate of a corresponding thermoplastic composition, wherein the corresponding thermoplastic composition is prepared in an otherwise similar manner as the burning-resistant thermoplastic composition but where the lignin material used for preparing the lignin-based filler has not been subjected to hydrothermal carbonization treatment.

18. The method of claim 17, wherein combining the at least one polymer and the lignin-based filler comprises combining the at least one polymer, the lignin based filler and additives and molding the formed burning-resistant thermoplastic composition.

19. An article comprising the burning-resistant thermoplastic composition of claim 1.

20. The article of claim 20, wherein thermoplastic composition has been shaped into the article by extrusion, injection molding, compression molding, blow molding, injection blow molding, injection stretch blow molding, thermoforming, vacuum forming, melt spinning, electrospinning, melt blowing, film blowing, film casting, extrusion coating, rotational molding, coextrusion, laminating, calendering, fused deposition modeling, or by any combination of these.

21. The use of the thermoplastic composition of claim 1 in a packaging, a housing, an automotive part, an aviation part, a marine part, a machine part, a sports equipment, a sports equipment part, a leisure equipment, a leisure equipment part, a tool, a part of a tool, a pipe, a membrane, a tube, a fitting, a bottle, a film, a bag, a sack, a textile, a rope, a container, a tank, an electrical component, an electronic component, a part for energy generation, a toy, an appliance, a kitchenware, a tableware, a flooring, a fabric, a medical application, a food contact material, a construction material, a drinking water application, and/or a furniture.
